(19) United States
(12) Patent Application Publication
(10) Pub. No.: US 2003/0197728 A1
(43) Pub. Date: Oct. 23, 2003

(54) Software personality wizard for ticket machines

(76) Inventor: Saravanan, Westmont, IL (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/233,466

(22) Filed: Sep. 4, 2002

Related U.S. Application Data
(60) Provisional application No. 60/372,816, filed on Apr. 17, 2002.

(51) Int. Cl. G09G 5/00

(52) U.S. Cl. 345/744; 345/866

(57) ABSTRACT

A display creating interface for a vending machine that includes a template generator that defines a template of a display having active areas and description areas associated with the active areas. An active area action generator is provided in communication with the template generator to define actions to be associated with the active areas. A program generator is provided in communication with the template generator and active area generator to generate programming code defining the template.

### PRIORITY

This application claims the benefit of U.S. Provisional Application No. 60/372,816 filed on Apr. 17, 2002.

### FIELD OF THE INVENTION

The present invention relates generally to generating displays. More particularly, the present invention relates to generating displays for vending machines.

### BACKGROUND OF THE INVENTION

Creating displays is a time intensive endeavor, which requires a large amount of programming. In creating displays, such as displays for vending machines, a display layout can be created to show what each screen should look like, how the screens should function and how the screens should link to one another. For example, when creating a display for a ticket vending machine, it may become necessary to determine what types of screens are needed for the purchase and distribution of a fare ticket. Within each screen different actions must be taken. For example, if a user wanted to purchase a metro ticket for a subway a first screen may include an area to select what type of ticket must be purchased. There may be three options, a monthly pass, a weekly pass, or a daily pass and a button associated with each of these options. Once one of these buttons is depressed, another screen may be displayed, such as payment type. For example, if a user chose to purchase a monthly pass and depressed the button associated with the monthly pass, a new screen would be displayed. This new display would request that the user choose a payment type. For example, the payment type may be credit card, debit card or cash. A button could be associate with each of these payment types. If the user chose credit card by depressing the button next to the credit card payment display, the display may prompt the user to insert a credit card into the appropriate slot. Once the credit card was inserted into the appropriate slot, another display may be shown, showing that transaction was complete and requesting the user to obtain the monthly pass from a storage bin below in the ticket vending machine.

From the above example, it is evident that there are many different displays and combinations of displays based on user inputs. In order to create these screens it would require someone to go through each of these situations to determine which display should be chosen or activated after each action item. Once a designer has determined all of the different displays and actions that they would want this ticket vending machine to accomplish, this would have to be communicated to a computer programmer. The computer programmer would then analyze these displays and action items to create a program to accomplish the goals of the display designer. As in any designing system involving more than one person, this may require many revisions and communications between the designer and the programmer in order to get the display to look exactly as the designer had anticipated and wished. Accordingly, a display creating interface for a vending machine is needed that will allow the display designer to create displays and action items without the use of a computer programmer.

In addition, it would be desirable to have an interface that would allow the user to see what the display would look like as the designer is creating the display.

It would further be desirable to have a system in which program codes such as C++ code are generated from this template and could become compiled and downloaded onto a vending machine.

### SUMMARY OF THE INVENTION

It is therefore a feature and advantage of the present invention to provide a display creating interface that will allow a designer to create display and action items without the use of a computer programmer. It is another feature and advantage of the present invention to provide a display creating interface which will create programming code from the templates which can be turned into an executable and downloaded onto the vending machine without the use of a computer programmer.

The above and other features and advantages are achieved through the use of a novel display creating interface for a vending machine as herein disclosed. In accordance with one embodiment of the invention, a display creating interface for a vending machine includes a template generator that defines a template of a display having active areas and description areas associated with active areas. An active area generator is provided in communication with the template generator to define actions to be associated with the active areas. A program generator is provided in communication with the template generator and the active area generator to generate programming code defining the template.

In accordance with another embodiment of the invention, a method for creating a display for a vending machine includes the steps of creating a display for a vending using a template having active areas and description areas associated with the active areas. Functions are created which are associated with the active areas. Programming code is then generated from the template.

In accordance with another embodiment of the present invention, a system for creating a display for a vending machine includes a means for creating a display for a vending machine using a template having active areas and description areas associated with the active areas. A means is provided for creating functions to be associated with the active areas. Another means is provided for generating programming code from the template.

There has thus been outlined, rather broadly, the more important features of the invention in order that the detailed description thereof that follows may be better understood, and in order that the contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a template used to make a display of the present invention.

FIG. 2 is a block diagram showing how to create a display of the present invention.

FIG. 3 is a flow diagram showing the method steps used in making a display of the present invention.

### DETAILED DESCRIPTION OF THE INVENTION

The present invention provides a way of creating displays using templates for vending machines. The present invention allows users to configure displays for vending machines, such as ticket vending machines, through the use of a wizard called a screen painting wizard. A user interface is provided so that transaction logic can be defined as a group of activities performed on a ticket vending machine by a user in order to buy goods being vended, supply information or monetary goods to the vending machine for the purpose of buying goods being vended, and collecting information of interest from the user in exchange for goods being vended.

An example of transaction logic is to buy a stored value from the vending machine after money is inserted into the vending machine. In order to accomplish this, the user will have to go through a series of screens or displays to indicate what type of transaction the user in interested. Money or some kind of credit can be inserted into the machine to purchase a service. Once the money or credit has been inserted into the machine, or otherwise credited, the vending machine can dispense a card or fare card in the case of a ticket vending machine for mass transportation. It is noted that the vending of these services is not only limited to ticket vending machines for mass transit, but could be used in other areas such as vending machines for tickets for movies, and products such as snacks or other services or products.

A single transaction for these products or services will have numerous screens associated with these transactions. Each screen will show and collect information from the user by using buttons that are depressed, or insertion of money or some type of credit system to the vending machine. The wizard will allow the programmer to design the look and feel of the entire screen or display. Through the use of the wizard, an interface will allow the user to design various messages on the screen, program various buttons on the screen, and design banners and pictures to appear on the screen.

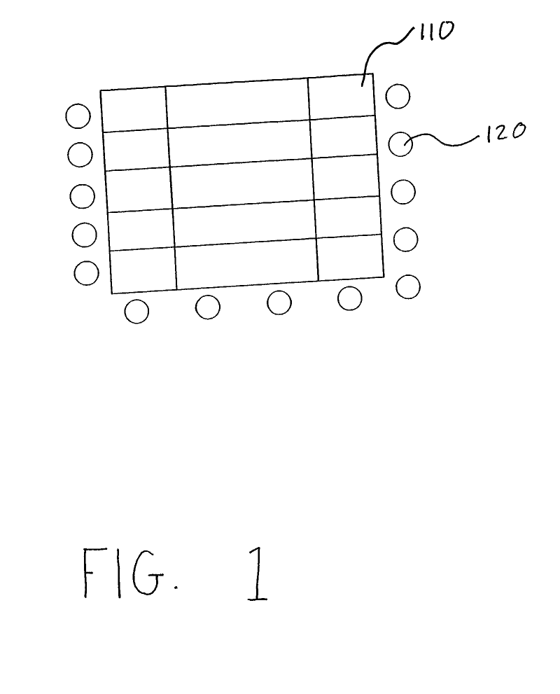

In some instances, the user interface is split up into 15 cells arranged in a 3 by 5 matrix. There are five buttons on each side of this matrix. Each button aligns with a row. A sticker is a user interface component that contains text banners and pictures. Stickers can be pasted onto a cell or can span multiple cells. Pressing a button next to the sticker will activate the sticker and launch into some type of function or transaction. FIG. 1 is an illustration of the 3×5 matrix having 15 cells, 110, and buttons 120. As is illustrated in FIG. 1, not only can buttons 120 be aligned with the rows, but buttons 120 could also be aligned with the columns. There are multiple configuration for aligning or arranging the buttons and cells. FIG. 1 is only an illustration of one possible embodiment of the invention.

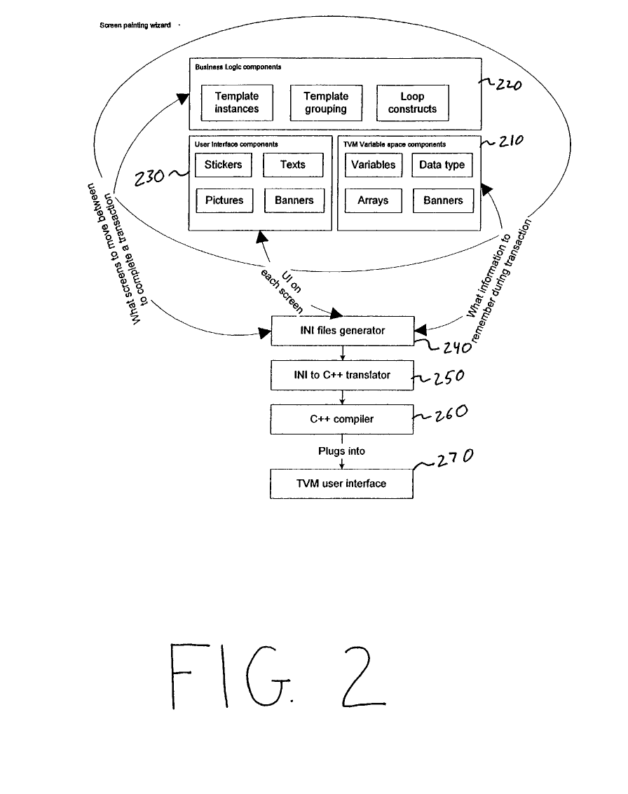

FIG. 2 is a block diagram showing how a display may be made using a template. In order to design a display using the templates, several design objectives must be laid out. First, the user must decide what the transaction objectives are, what actions will be necessary to achieve these objectives and in what order each action should occur. Along these lines, it must be determined what types of information are needed from the user, whether money should be collected from the user, whether some type of fare card should be collected from the user, what needs to be vended etc. The second design objective is to determine what type of information needs to be remembered during a transaction and posted to a database. The database will keep information such as user and in the case of mass transportation, destinations, times, etc. Another design objective is to determine individual screens that must be shown for each transaction. Once the screens are decided, buttons must be created to execute functions or transactions on each screen. Another objective is to design how to vend or distribute receipts, fare cards, etc., to the user for each transaction.

Once these design objectives are laid out, the designer can use the wizard to create displays to achieve the design objectives. As shown in box 210 in FIG. 2, variables and data types are created to store information that need to be remembered during a transaction and later posted to a database. As shown in box 220 of FIG. 2, a template of instances for each transaction objective must be created. This may involve breaking down the objectives into further steps. For example, one objective may be to collect money from the user. This step may be broken into two sub steps. First, the mode of payment would have to be decided (i.e., credit/debit/cash/metro card) and the means for actually getting the payment, i.e. create a different template instance based on what is selected as the mode of payment.

In box 230 of FIG. 2, screens are created. Stickers and banners must be designed for each of the screens where a sticker is placed right next to a button will activate the button. Pressing that button on this screen will then launch into another screen. This can be specified in the sticker. As shown in box 230, groups are created of the template instances to complete a transaction. The wizard will have language constructs, which will allow the user to create groups. Some constructs allow looping inside a set of templates for a preset number of times. This allows for cases like allowing a user to purchase more than one fare card at a time, or other types of looping functions or transactions.

A designer can also attach the creative transaction to some sticker and place it on the main screen, so that the end user can start off with this transaction by pressing the button next to the screen. This is useful when there are multiple types of services or products, which are associated with a single vending machine. This will give the user the ability to choose which transaction the user wishes to engage in without going through too many multiple screens.

The generation of the display through the template using the screen painting wizard is done through box 240 where INI files are generated or any other type of programming code files can be generated. Once the display and screen have been created through the template painting wizard, the wizard can be directed to create a programming code, such as C++ files. In box 250 the INI code is translated into C++ code. In box 260, the C++ code is compiled into executable code to create an executable file, which can be downloaded and run on a vending machine, such as a ticket vending machine. Once the executable file is created, the executable file can be downloaded into a ticket vending machine user interface (box 270). In one embodiment of the invention, these executable files can be moved to a LINUX box where a compile will create all binaries needed for the final TVM. These can then be downloaded into the actual TVM.

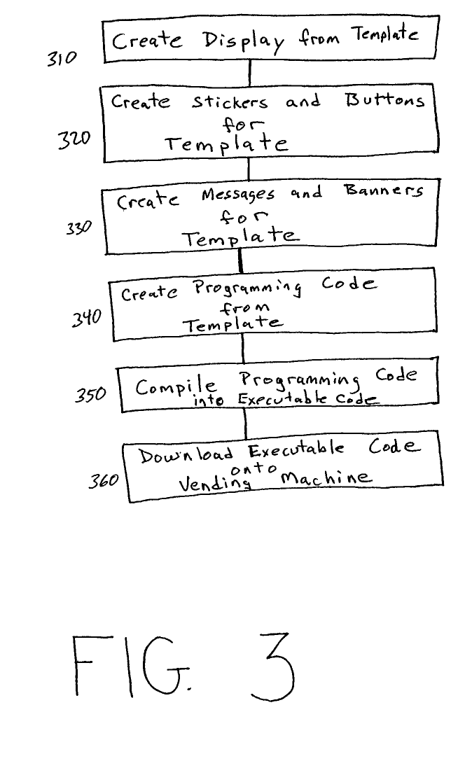

FIG. 3 shows the method steps that can be used in creating a display using a template through the display wizard interface. In step 310, the general design of the template for each display is created. In step 320, stickers and button for the template are created where certain buttons may be associated with other stickers. When the buttons are depressed, certain transactions can be associated with the buttons and can jump to other displays or other transactions or functions.

In step 330, other messages or banners can also be created which are not associated with the buttons, such as advertisements or general information. Once all of the displays, stickers and buttons have been created to the designer's preferences, programming code is created in step 340.

In step 340 the wizard interface can create C++ files. These files can be moved to a LINUX box where a compile will create all binaries needed for the final TVM. In step 350 the programming code is compiled into an executable code. In step 360, the executable code is downloaded onto a vending machine.

The many features and advantages of the invention are apparent from the detailed specification, and thus, it is intended by the appended claims to cover all such features and advantages of the invention which fall within the true spirit and scope of the invention. Further, since numerous modifications and variations will readily to those skilled in the art, it is not desired to limit the invention to the exact construction and operation and illustrated, and accordingly, all suitable modifications and equivalents may be resorted to, falling within the scope of the invention.

The invention claimed is:

1. A display creating interface for a vending machine comprising:
a template generator that defines a template of a display having active areas and description areas associated with the active areas;
an active area action generator in communication with said template generator to define actions to be associated with said active areas; and
a program generator in communication with said template generator and said active area generator to generate programming code defining said template.

2. The display creating interface as recited in claim 1 further comprising a compiler in communication with said program generator to compile the programming code into an executable file.

3. The display creating interface as recited in claim 2 further comprising a download system in communication with said compiler to download the executable file from the interface to the vending machine.

4. The display creating interface as recited in claim 1 wherein said program generator generates C++ files.

5. The display creating interface as recited in claim 1 wherein said template generator further comprises a message area generator to display information not associated with any of said active areas.

6. The display creating interface as recited in claim 1 wherein said template generator defines multiple displays linked to one another wherein each display is linked to an active area so that when an active area is selected the display linked with the active area is displayed.

7. The display creating interface as recited in claim 1 wherein said template comprises of 15 cells arranged in a 3×5 matrix.

8. A method for creating a display for a vending machine comprising the steps of:
creating a display for a vending machine using a template having active areas and description areas associated with the active areas;
creating functions to be associated with the active areas; and
generating programming code from the template.

9. The method as recited in claim 8 further comprising the step of compiling the programming code into an executable for use in the vending machine.

10. The method as recited in claim 9 further comprising the step of downloading the executable file from the interface to the vending machine.

11. The method as recited in claim 8 wherein the step of generating programming code generates C++ files.

12. The method as recited in claim 8 further comprising the step of generating a message area to display information not associated with any of said active areas.

13. The method as recited in claim 8 further comprising the step of generating multiple displays linked to one another wherein each display is linked to an active area so that when an active area is selected the display linked with the active area is displayed.

14. The method as recited in claim 8 wherein said template comprises of 15 cells arranged in a 3×5 matrix.

15. A system for creating a display for a vending machine comprising:
a means for creating a display for a vending machine using a template having active areas and description areas associated with the active areas;
a means for creating functions to be associated with the active areas; and
a means for generating programming code from the template.

16. The system as recited in claim 15 further comprising a means for compiling the programming code into an executable for use in the vending machine.

17. The system recited in claim 16 further comprising a means for downloading the executable file from the interface to the vending machine.

18. The system as recited in claim 15 wherein said means for generating programming code generates C++ files.

19. The system as recited in claim 15 further comprising a means for generating a message area to display information not associated with any of said active areas.

20. The system as recited in claim 15 further comprising a means for generating multiple displays linked to one another wherein each display is linked to an active area so that when an active area is selected the display linked with the active area is displayed.

21. The system as recited in claim 15 wherein said template comprises of 15 cells arranged in a 3×5 matrix.
